(19) United States
(12) Patent Application Publication
(10) Pub. No.: US 2015/0034653 A1
(43) Pub. Date: Feb. 5, 2015

(54) Retaining collar for liner-containing container

(71) Applicant: Janet Sirko, Whitby (CA)

(72) Inventor: Janet Sirko, Whitby (CA)

(21) Appl. No.: 14/121,033

(22) Filed: Jul. 23, 2014

(30) Foreign Application Priority Data
Aug. 1, 2013 (CA) 2882667

(51) Int. Cl. B65F 1/06; B65D 25/16

(52) U.S. Cl. CPC B65F 1/06; B65D 25/16
USPC 220/495.08

(57) ABSTRACT

The retaining collar is seated on the upper edge of the outer shell of a container and has the same shape as the upper edge. The collar has a pair of side walls between which the upper edge is accommodated. The upper margin of a liner is also accommodated between the side walls of the collar. The collar is composed of resiliently deformable material such that when the upper edge of the outer shell and the upper margin of the liner are between the side walls of the collar, the side walls resiliently and releasably secure the liner to the outer shell of the container.

### FIELD OF THE INVENTION

This invention relates to containers having outer shells and inner liners and more particularly to a retaining collar for removably securing a liner within an outer shell.

### CROSS-REFERENCE TO RELATED PRIOR APPLICATION

This application claims priority pursuant to 35 USC 119 of Canadian application no. 2,822,667 filed in the Canadian Intellectual Property Office on Aug. 1, 2013 which application is herein incorporated herein by reference in its entirety.

### BACKGROUND OF THE INVENTION

Plastic containers are generally used in kitchens to hold compost and other organic matter. The containers are usually closed to confine objectionable odours from the organic matter within the containers and they usually contain disposable liners for the organic matter to facilitate easy disposal.

Liquid may leak from disposable liners into the outer shells of the container unless the liners are properly attached within the outer shells. The liner must be attached to the rim or top edge of the outer shell. If the perimeter of the mouth of the liner is less than the perimeter of the top edge of the shell, some portion of the mouth will not be attached to the top edge and liquid may leak from there into the outer shell. Moreover some of the compost which is dropped into the container may not drop into the liner but instead fall through the gap between the liner and the outer shell and settle in the bottom of the outer shell.

If the perimeter of the mouth of the liner is larger than the perimeter of the top edge of the outer shell some of the compost and liquid may fall outside the container from the part of the mouth not attached to the top edge of the shell.

I have invented means for attaching a liner within the outer shell of a container so that leakage of liquid from the liner is minimized even if the mouth of the liner is larger than the perimeter of the rim of the outer shell. My invention consists of a retaining collar which extends along the entire top edge or rim of the outer shell of a container. The entire top margin of the liner is confined within the retaining collar whether it is the same perimeter as the top edge or rim or larger. The collar is removably attached to the rim of the outer shell of the container by resilient deformation of the collar to conform to the shape of the rim.

### SUMMARY OF THE INVENTION

Briefly, the retaining collar of my invention has a top wall which is adapted to be seated on the upper edge or rim of an outer shell of a container and which follows the contours of the upper edge. The retaining collar is provided with a pair of outer and inner side walls which extend downwardly from the top wall and which are separated from one another by a space which is adapted to receive both the upper edge of the container and the top margin of the liner. The side walls are composed of resiliently deformable material such that the space between the side walls expands to receive the upper edge and top margin of the liner and releasably retain them within the space.

### DESCRIPTION OF THE DRAWINGS

The retaining collar of the invention is described in detail with reference to the accompanying drawings in which:

FIG. 1 is a perspective view of the retaining collar in conjunction with an open container;

FIG. 2 is a perspective view of the retaining collar and the container when closed;

FIG. 3 is a perspective view of the retaining collar;

FIG. 4 is an elevation of the retaining collar on line 4-4 of FIG. 3;

FIG. 5 is a plan view of the retaining collar;

FIG. 6 is a perspective view of a second embodiment of the collar and liner when the container is open; and

FIG. 7 is a perspective view of the second embodiment of the collar and liner when the container is closed.

Like reference characters refer to like parts throughout the description of the drawings.

### DESCRIPTION OF PREFERRED EMBODIMENTS

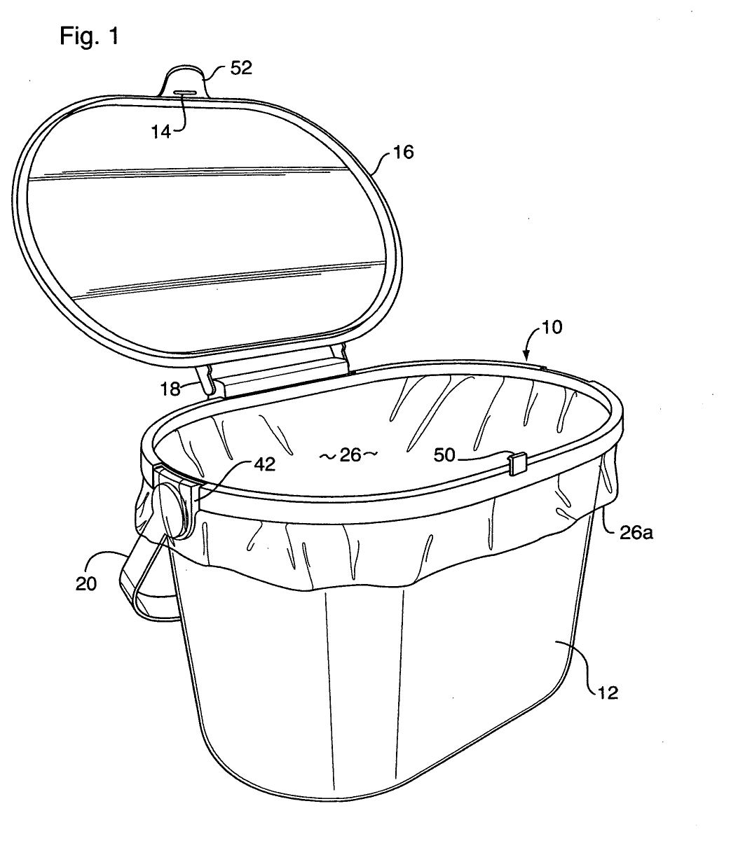

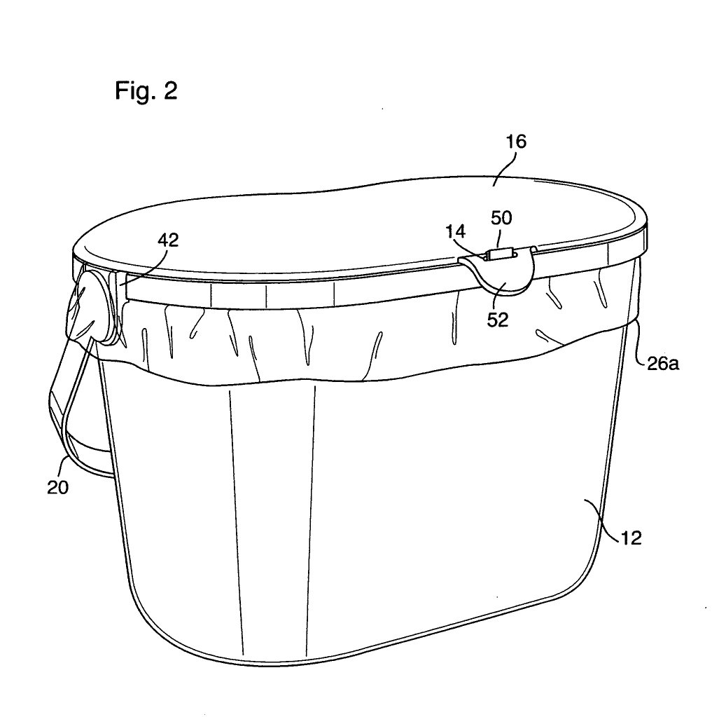

With reference to FIGS. 1 and 2, the subject retaining collar, generally 10, is shown attached to the upper edge or rim of an outer shell 12 of a container The rim is in the shape of an oval but it may be other shapes such as circular, square and rectangular.

A lid 16 is interconnected by a hinge 18 to the container. The container has a handle 20 which, when the container is not being carried, is angled downward as illustrated but swings upward for use. A conventional disposable liner 26 is disposed within the container, typically for compost, fruits and vegetables. The liner has an upper margin 26a which overlaps the upper edge of the container and which defines the mouth of the liner.

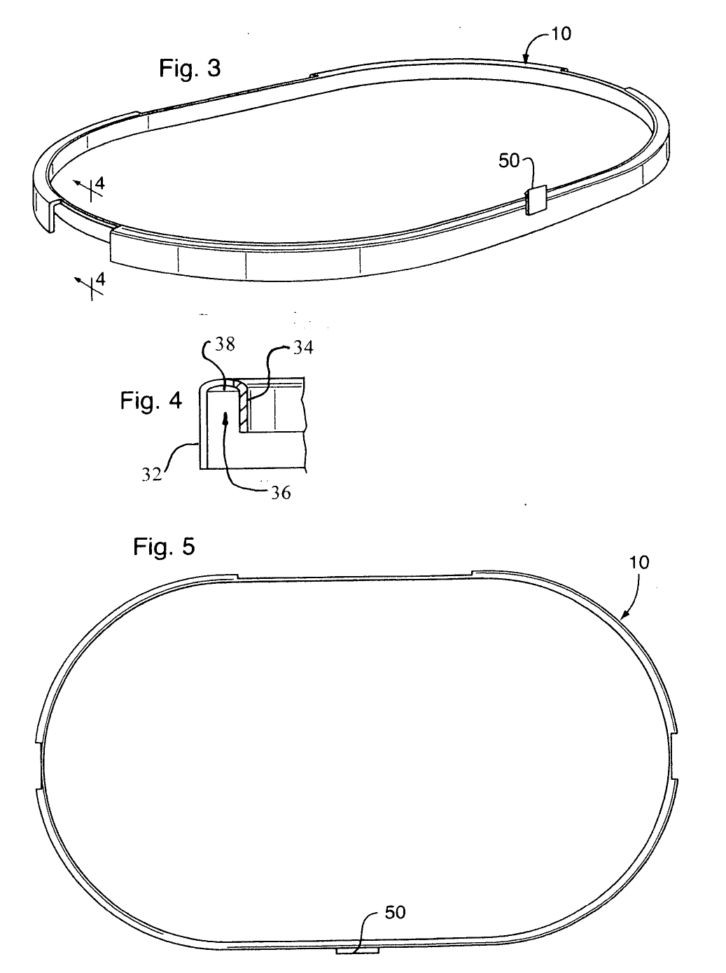

With reference to FIGS. 3 and 4, the retaining collar is seated on the upper edge or rim of the outer shell of the container and follows its contour. The collar has a top wall 30 which is seated on the upper edge while outer and inner side walls 32, 34, respectively, extend down wardly from the top wall. The side walls are located adjacent to the outer and inner vertical walls respectively of the outer shell. The space 36 between the two side walls is slightly less than the thickness of the vertical wall 38 of the outer shell.

The retaining collar is composed of resiliently deformable material and deforms slightly to fit over the upper edge or rim of the outer shell and remains snugly attached to it. It also deforms slightly more when the top margin of the liner is wrapped or folded over the upper edge as illustrated in FIGS. 1 and 2. The retaining collar accordingly secures the liner to the outer shell until the side walls of the retaining collar are separated sufficiently to allow the retaining collar to be removed from the container.

Since the retaining collar is resiliently deformable, lifting the retaining collar relative to the container will cause the side walls of the collar to separate so that the collar can be removed from the container. The collar is designed so that only a slight upward force is sufficient to separate the two. As a result of the flexibility of the collar, it can be attached to the rim of the outer shell of a container which may not be exactly the same shape of the collar when undeformed.

With reference to FIGS. 1-3 and 5, a gap 40 is formed in the outer side wall of the retaining collar to receive a protuberance 42 for pivotal connection of the handle 20 to the outer shell of the container. A larger gap 44 is also formed in the outer side wall to accommodate hinge 18. A tab 50 is provided on the front edge of the collar. The tab fits into a slot 14 in a tongue 52 which is attached to the front edge of the lid. The tab and tongue cooperate to hold the lid closed.

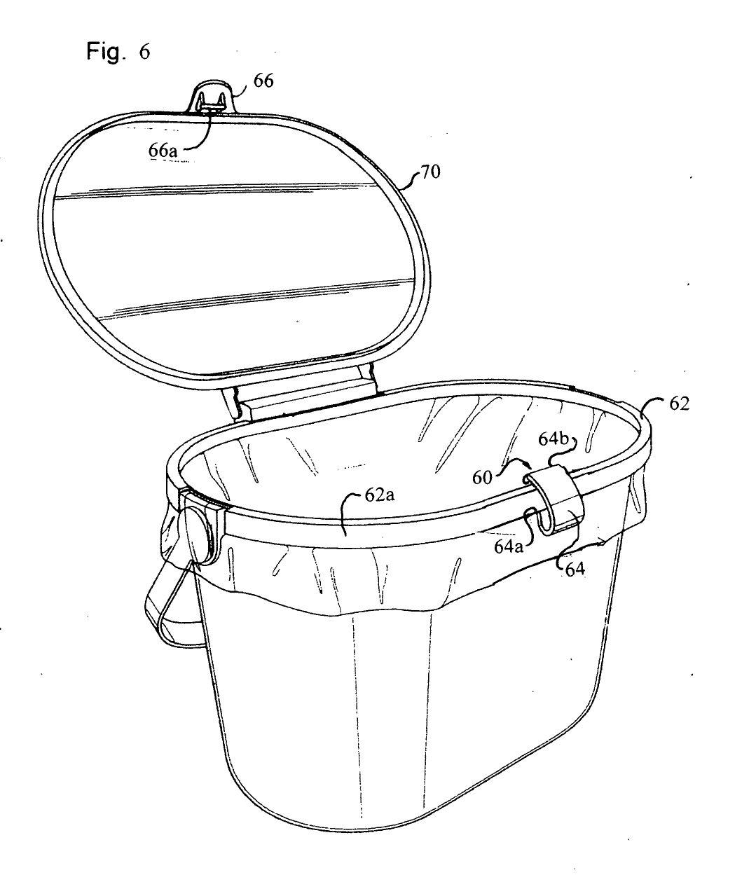

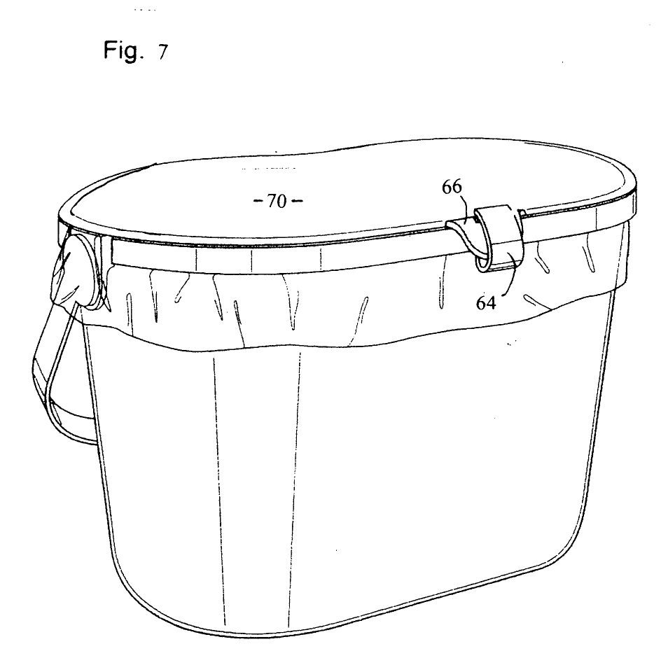

With reference to FIGS. 6 and 7, the illustrated container is the same as the previously described container except for the means by which the container is held closed. In this regard, a catch, generally 60, is provided on the retaining collar 62. The catch consists of a generally U-shaped resiliently deformable retainer 64 in which its lower inner end 64a is attached or is integral with the front wall of the collar and its upper outer end 64b is curled back to frictionally engage the upper wall of lid 70. On the lower wall of the ear there is a finger 66a which frictionally contact the front wall 62a of the retaining collar when the lid is shut as illustrated in FIG. 7.

The retainer is then attached to the ear and causes the lid to bend downward with resulting closure or substantial narrowing of the gap between the lid and the upper edge of the outer shell. As the gap closes or narrows, the odour from the contents of the liner diminishes. In the absence of the catch, there is a gap because of the additional height of the rim resulting from the presence of the retaining collar and odour from the contents of the liner may escape through the gap.

It will be understood, of course, that modifications can be made in the structure of the subject retaining collar without departing from the scope and purview of the invention as defined in the appended claims.

I claim:

1. A retaining collar for removably securing a liner within an outer shell of a container having an upper opening defined by a rim, said liner having an upper margin which defines a mouth and an interior, said retaining collar having a top wall which is adapted to be seated on said rim and which follows the contours of said rim; a pair of outer and inner side walls which extend down-wardly from said top wall, said side walls being separated from one another by a space which is adapted to receive both said rim and said upper margin, said side walls being composed of resiliently deformable material such that when said rim and said upper margin are within said space, said side walls resiliently contact said upper margin and releasably secure said upper margin to said rim.

2. The retaining collar of claim 1 wherein said top wall of said retaining collar is resiliently deformable.

3. The retaining collar of claim 1 further including a lid hinged to said container for closing said container and a catch for attaching said lid to said rim.

4. The retaining collar of claim 3 wherein said catch includes a tab which extends upwardly from said rim and a tongue fastened to said lid, said tab having an opening for removable insertion of said pin therein with resulting attachment of said lid to said rim.

5. The retaining collar of claim 3 wherein said catch includes a retainer attached to said retaining collar and an ear attached to said lid, said retainer being attached to said collar and being resiliently deformable, said retainer, when an inward force is applied thereto, being adapted to frictionally engage said lid when said lid is closed with resulting narrowing of the gap between said lid and said rim.
